(19) United States
(12) Patent Application Publication
(10) Pub. No.: US 2009/0112777 A1
(43) Pub. Date: Apr. 30, 2009

(54) Method of providing variable subscription-based access to an emergency shelter

(76) Inventor: Barrett H. Moore, Winnetka, IL (US)

Correspondence Address: FITCH EVEN TABIN AND FLANNERY, 120 SOUTH LASALLE STREET, SUITE 1600, CHICAGO, IL, 60603-3406, US

(21) Appl. No.: 11/461,624

(22) Filed: Aug. 1, 2006

Related U.S. Application Data
(63) Continuation-in-part of application No. 11/384,037, filed on Mar. 17, 2006.
Application No. 11/384,037 is a continuation-in-part of application No. 11/394,350, filed on Mar. 30, 2006.
Application No. 11/394,350 is a continuation-in-part of application No. 11/279,333, filed on Apr. 11, 2006.
Application No. 11/279,333 is a continuation-in-part of application No. 11/379,929, filed on Apr. 24, 2006.
Application No. 11/379,929 is a continuation-in-part of application No. 11/381,247, filed on May 2, 2006.
Application No. 11/381,247 is a continuation-in-part of application No. 11/381,257, filed on May 2, 2006.
Application No. 11/381,257 is a continuation-in-part of application No. 11/381,265, filed on May 2, 2006.
Application No. 11/381,265 is a continuation-in-part of application No. 11/381,277, filed on May 2, 2006.
Application No. 11/381,277 is a continuation-in-part of application No. 11/383,022, filed on May 12, 2006.
Application No. 11/383,022 is a continuation-in-part of application No. 11/420,594, filed on May 26, 2006.
Application No. 11/420,594 is a continuation-in-part of application No. 11/421,694, filed on Jun. 1, 2006.
Application No. 11/421,694 is a continuation-in-part of application No. 11/425,043, filed on Jun. 19, 2006.
Application No. 11/425,043 is a continuation-in-part of application No. 11/426,231, filed on Jun. 23, 2006.
Application No. 11/426,231 is a continuation-in-part of application No. 11/456,472, filed on Jul. 10, 2006.
Application No. 11/456,472 is a continuation-in-part of application No. 11/461,605, filed on Aug. 1, 2006.

(51) Int. Cl. G06Q 90/00; G06K 7/01

(52) U.S. Cl. 705/500; 235/382.5

(57) ABSTRACT

At least two types of consideration-based private civil security subscriptions are accepted (105) from subscribers with respect to providing civilly-catastrophic event based access to secure emergency shelters. Access to the shelters is then selectively provided (110) for authorized beneficiaries of the subscribers based at least in part on the type of subscription possessed by the authorized beneficiary. Holders of certain types of private civil security subscriptions may have access to a plurality (115) of secure emergency shelters or to secure emergency shelters having increased benefits (135) relative to other secure emergency shelters. The provider of the secure emergency shelters can provide varying levels of comfort or security based upon the type of subscription purchased by a subscriber, and authorized beneficiaries will have predictable access to a pre-provisioned secure emergency shelter upon the occurrence of a civilly-catastrophic event.

### RELATED APPLICATIONS

This application comprises a continuation-in-part of:

SUBSCRIPTION-BASED PRIVATE CIVIL SECURITY FACILITATION METHOD as filed on Mar. 17, 2006 and having application Ser. No. 11/384,037;

SUBSCRIPTION-BASED CATASTROPHE-TRIGGERED MEDICAL SERVICES FACILITATION METHOD as filed on Mar. 30, 2006 and having application Ser. No. 11/394,350;

PERSONAL PROFILE-BASED PRIVATE CIVIL SECURITY SUBSCRIPTION METHOD as filed on Apr. 11, 2006 and having application Ser. No. 11/279,333;

RADIATION SHELTER KIT APPARATUS AND METHOD as filed on Apr. 24, 2006 and having application Ser. No. 11/379,929;

FRACTIONALLY-POSSESSED UNDERGROUND SHELTER METHOD AND APPARATUS as filed on May 2, 2006 and having application Ser. No. 11/381,247;

SUBSCRIPTION-BASED CATASTROPHE-TRIGGERED TRANSPORT SERVICES FACILITATION METHOD AND APPARATUS as filed on May 2, 2006 and having application Ser. No. 11/381,257;

SUBSCRIPTION-BASED MULTI-PERSON EMERGENCY SHELTER METHOD as filed on May 2, 2006 and having application Ser. No. 11/381,265; and

SUBSCRIPTION-BASED CATASTROPHE-TRIGGERED RESCUE SERVICES FACILITATION METHOD AND APPARATUS as filed on May 2, 2006 and having application Ser. No. 11/381,277;

DOCUMENT-BASED CIVILLY-CATASTROPHIC EVENT PERSONAL ACTION GUIDE FACILITATION METHOD as filed on May 12, 2006 and having application Ser. No. 11/383,022;

RESCUE CONTAINER METHOD AND APPARATUS as filed on May 26, 2006 and having application Ser. No. 11/420,594;

PURCHASE OPTION-BASED EMERGENCY SUPPLIES PROVISIONING METHOD as filed on Jun. 1, 2006 and having application Ser. No. 11/421,694;

SUBSCRIPTION-BASED PRE-PROVISIONED TOWABLE UNIT FACILITATION METHOD as filed on Jun. 12, 2006 and having application Ser. No. 11/423,594;

RADIATION-BLOCKING BLADDER APPARATUS AND METHOD as filed on Jun. 19, 2006 and having application Ser. No. 11/425,043;

PRIVATE CIVIL DEFENSE-THEMED TELEVISION BROADCASTING METHOD as filed on Jun. 23, 2006 and having application Ser. No. 11/426,231; and

EMERGENCY SUPPLIES PRE-POSITIONING AND ACCESS CONTROL METHOD as filed on Jul. 10, 2006 and having application Ser. No. 11/456,472; the contents of which are fully incorporated herein by this reference.

### TECHNICAL FIELD

This invention relates generally to providing access to emergency shelters and provisions.

### BACKGROUND

Many citizens of the world have long passed the point when a ready availability of the basic necessities of life is satisfactory in and of itself. Today's consumer-oriented citizens demand, and often receive, an incredibly diverse and seemingly ever-growing cornucopia of consuming and experiential options. Such riches are typically based, in turn, upon a highly interdependent series of foundational infrastructure elements. Examples of the latter include, but are certainly not limited to:
transportation infrastructure such as roads, bridges, railways, and so forth that facilitate the inexpensive and rapid movement of sometimes perishable goods from source to consumer;
communications infrastructure such as telephones, television, radio, and the Internet that facilitate the inexpensive and rapid sharing of news, advice, information, and entertainment; and
the totality of civil services such as police services, fire fighting services, medical services, and so forth that facilitate a sufficient degree of order and predictability to, in turn, permit the complex series of inter-related interactions that modern society requires in order to operate.

As powerful as the machinery of modern life appears, however, modern citizens are today perhaps more at risk of experiencing a serious disruption in their ability to prosper or even to survive en mass than is generally perceived. Providing the necessities of life in general requires a lot of things to all operate, more or less, correctly. To put it another way, a serious disruption to any significant element of civilized infrastructure can produce catastrophic results for a broad swatch of a given civil community. Any number of natural and/or non-naturally-caused events can sufficiently disrupt society's infrastructure and ability to provide one or more life-sustaining resources such as water, nutrition, shelter, and the like.

Many people believe and trust that their government (local, regional, and/or national) will provide for them in the event of such a civilly-catastrophic event. And, indeed, in the long view such is clearly a legitimate responsibility owed by any government to its citizens. That such is a consummation devoutly to be wished, however, does not necessarily make it so. Hurricane Katrina provided some insight into just how unprepared a series of tiered modern governmental entities may actually be to respond to even basic survival needs when a civilly-catastrophic event occurs.

Such insights, of course, are not particularly new. Civil preparedness shortcomings occasionally attract public attention and niche marketing opportunities exist with respect to provisioning the needs of so-called survivalists. Indeed, there are those who spend a considerable amount of their time and monetary resources attempting to ready themselves to personally survive a civilly-catastrophic event. Therein, however, lies something of a conundrum.

On the one hand, modern governments typically do little to proactively ensure the bulk survival (let alone the comfort) of their citizens in the face of most civilly-catastrophic events. On the other hand, attempting to take responsible actions to reasonably ensure one's own safety and security can become, in and of itself, nearly a full-time avocation and leave little time to actually enjoy the conveniences and opportunities of modern life. Such individual actions may even be frowned upon by the greater part of society which has grown accustomed and falsely secure with existing efficient just-in-time delivery systems that provide the illusion of plenty while undercutting the perception of risk.

### BRIEF DESCRIPTION OF THE DRAWINGS

The above needs are at least partially met through provision of the method of providing variable subscription-based access to an emergency shelter described in the following detailed description, particularly when studied in conjunction with the drawings, wherein:

FIG. 1 comprises a flow diagram as configured in accordance with various embodiments of the invention;

FIG. 2 comprises a block diagram view as configured in accordance with various embodiments of the invention;

FIG. 3 comprises a flow diagram as configured in accordance with various embodiments of the invention; and

FIG. 4 comprises a flow diagram as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, at least two types of consideration-based private civil security subscriptions are accepted from subscribers with respect to providing civilly-catastrophic event based access to secure emergency shelters. Access to the secure emergency shelters is then selectively provided for authorized beneficiaries of the subscriptions based at least in part on the type of consideration-based private civil security subscription possessed by the authorized beneficiary.

The nature of the selectivity of access to the shelters can vary. For instance, holders of certain types of private civil security subscriptions may have access to a plurality of secure emergency shelters or may have access to secure emergency shelters having increased benefits relative to other secure emergency shelters. In this way, the provider of the secure emergency shelters can provide varying levels of comfort, convenience, and/or security based upon the type of subscription purchased by a subscriber, and authorized beneficiaries of such consideration-based private civil security subscriptions will have predictable and reliable access to a pre-provisioned secure emergency shelter upon the occurrence of a catastrophic event. Access to secure emergency shelters may also be card-based such that access is only provided to those possessing an access card, and the access card may indicate the type and level of access a person possessing the access card may have.

These steps are facilitated without dependency upon governmental oversight, participation, or control. The particular resources provided at the secure emergency shelters can vary with the needs and requirements of the authorized beneficiaries. Importantly, an individual can take important steps to bring a considerably improved measure of security into their lives without having to effectively become a full-time survivalist; such individuals can, in short, continue to enjoy their chosen vocations and standard of living knowing that, should a civilly-catastrophic event indeed be visited upon them, they will have extraordinary access to one or more resources that are critical to human life.

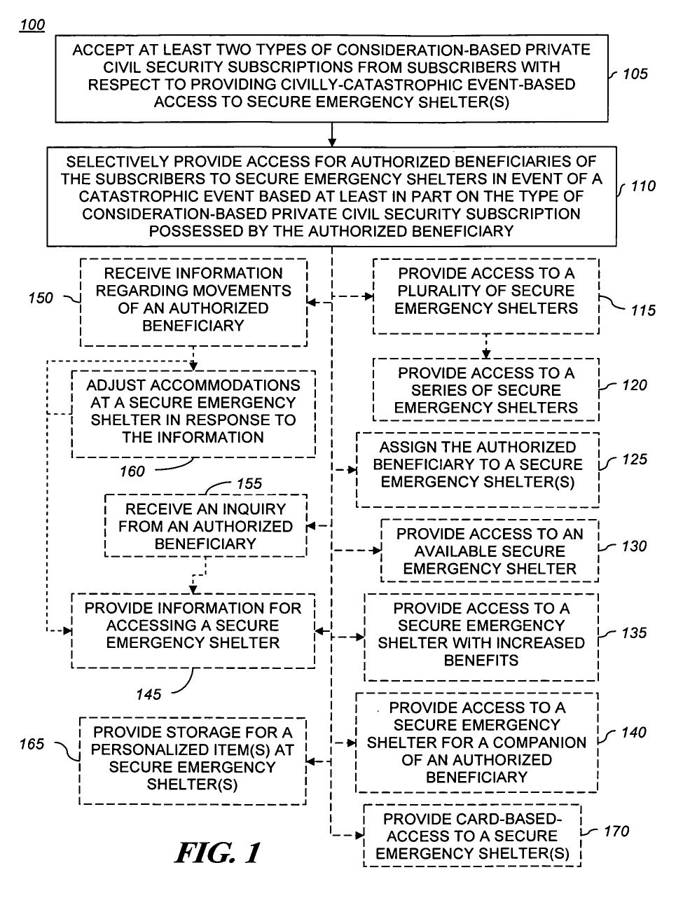

These and other benefits may become clearer upon making a thorough review and study of the following detailed description. Referring now to FIG. 1, an illustrative process 100 provides for accepting 105 at least two types of consideration-based private civil security subscriptions from subscribers with respect to providing civilly catastrophic event-based access to secure emergency shelters. The shelters may be designed to protect one person, to be mobile or immobile, or to be secure multi-person emergency shelters. Then, in event of a catastrophic event, the process 100 provides for selectively providing 110 access for authorized beneficiaries of the subscribers to the secure emergency shelters based at least in part on the type of consideration-based private civil security subscription possessed by the authorized beneficiary.

Thus, a given subscriber may provide such a subscription for an authorized beneficiary other than themselves. Such might occur, for example, when one family member procures such a subscription for one or more other family members. Another example would be for a company to subscribe on behalf of named key employees, family members of such key employees, and so forth. Other examples no doubt exist.

By one approach, these subscriptions may be accepted by, for example, a for-profit business. By another approach a not-for-profit business (such as a membership-based entity) may be the appropriate entity to offer and accept such subscriptions.

As noted, these teachings provide for a subscription-based approach. As used herein, the term “subscription” shall be understood to refer to and encompass a variety of legal mechanisms. Some relevant examples include, but these teachings are not limited to, subscription mechanisms such as:
time-limited rights of access (as where a subscription provides access rights for a specific period of time, such as one year, in exchange for a corresponding series of payments);
event-limited rights of access (as where a subscription provides access rights during the life of a given subscriber based upon an up-front payment in full and where those access rights terminate upon the death of the subscriber or where, for example, a company purchases a subscription for a key employee and those corresponding rights of access terminate when and if that key employee leaves the employment of that company);
inheritable rights of access (as may occur when the subscription, by its own terms and conditions, provides a right of access that extends past the death of a named subscription beneficiary and further allows for testate and/or intestate transfer to an heir);
rights of access predicated upon a series of periodic payments (as where a subscription provides access rights during, for example, predetermined periods of time on a periodic basis as where a subscriber offers month-by-month payments to gain corresponding month-by-month access rights);
rights of access predicated upon a one-time payment (as may occur when a subscriber makes a single payment to obtain a time-based or event-based duration of access rights or, if desired, when a single payment serves to acquire a perpetual right of access that may be retained, transferred, inherited, or the like);
ownership-based rights of access (as may occur when the subscription provides for ownership rights in the at least one life-sustaining resource);
non-transferable rights of access (as may occur when the subscription, by its terms and conditions, prohibits transfer of the right of access to the at least one life-sustaining resource from a first named beneficiary to another);
transferable rights of access (as may occur when the subscription, by its terms and conditions, permits conditional or unconditional transfer of the right of access to the at least one life-sustaining resource from a first named beneficiary to another);
membership-based rights of access (as may occur when the subscription, by its terms and conditions, establishes a membership interest with respect to the accorded right of access such as, for example, a club-based membership);
fractionally-based rights of access (as may occur when the subscription, by its terms and conditions, establishes a divided or undivided co-ownership interest by and between multiple subscription beneficiaries with respect to a right to access the at least one life-sustaining resource); and/or
non-ownership-based rights of access (as may occur when the subscription, by its terms and conditions, establishes the aforementioned right of access via, for example, a lease, rental, or borrowing construct).

Those accepting subscriptions will typically provide and maintain the secure emergency shelters and the resources provided therewith, thereby incurring significant costs. To adequately scale the costs for the provision and maintenance of the secure emergency shelters, the provider may require the subscribers to acquire different subscriptions, in exchange for different amounts of consideration, for the right to access particular secure emergency shelters or a number of secure emergency shelters.

Thus, the types of consideration-based private civil security subscriptions may include at least a first type that provides relatively limited access to the secure emergency shelters and a second type that provides relatively less limited access to the secure emergency shelters. As but one example in this regard, the first type of consideration-based private civil security subscription might permit access to only a relatively few of the plurality of secure emergency shelters, and the second type of consideration-based private civil security subscription might permit access to substantially any of the plurality of secure emergency shelters. Optionally, the first type of consideration-based private civil security subscription permits access to only a predetermined one of the plurality of secure emergency shelters. By requiring differing amounts of consideration for different rights of access to the secure emergency shelters, the provider of the secure emergency shelters can better maintain the secure emergency shelters while assuring adequate resources for the secure emergency shelters in the event of a civilly-catastrophic event.

As used herein, “civilly-catastrophic event” will be understood to refer to an event that substantially and materially disrupts a society's local, regional, and/or national infrastructure and ability to provide in ordinary course for the at least one life-sustaining resource that is the subject of the subscription. Such a civilly-catastrophic event can include both a precipitating event (which may occur over a relatively compressed period of time or which may draw out over an extended period of time) as well as the resultant aftermath of consequences wherein the precipitating event and/or the resultant aftermath include both the cause of the infrastructure interruption as well as the continuation of that interruption.

A civilly-catastrophic event can be occasioned by any of a wide variety of natural and/or non-natural disasters. Examples of natural disasters that are potentially capable of initiating a civilly-catastrophic event include, but are not limited to, extreme weather-related events (such as hurricanes, tsunamis, extreme droughts, widespread or unfortunately-targeted tornadoes, extreme hail or rain, and the like, flooding, and so forth), extreme geological events (such as earthquakes, volcanic activity, and so forth), extreme space-based collisions (as with comets, large asteroids, and so forth), extreme environmental events (such as widespread uncontrolled fire or the like), and global or regional pandemics, to note but a few.

Examples of non-natural disasters capable of initiating a civilly-catastrophic event include both unintended events as well as intentional acts of war, terrorism, madness or the like. Examples of non-natural disasters capable of such potential scale include, but are not limited to, nuclear-related events (including uncontrolled fission or fusion releases, radiation exposure, and so forth), acts of war, the release of deadly or otherwise disruptive biological or chemical agents or creations, and so forth.

Optionally, the process 100 includes providing access 115 to a plurality of secure emergency shelters for an authorized beneficiary possessing a first type of consideration-based private civil security subscription. In this way, an authorized beneficiary possessing the first type of subscription then may access more than one secure emergency shelter, thereby increasing the survival options for that authorized beneficiary upon the occurrence of a civilly-catastrophic event.

The plurality of secure emergency shelters to which an authorized beneficiary has access may be further determined or defined in any number of ways. For instance, the plurality of secure emergency shelters may include any secure emergency shelter having a particular category of amenities. In this way, a subscriber may gain access to certain secure emergency shelters having certain features desirable to the subscriber or authorized beneficiary. Further, the plurality of secure emergency shelters may include any secure emergency shelter, any secure emergency shelter within a specified geographical area, or any secure emergency shelter within a given distance from a rally point. Thus, a provider of this process may allow a subscriber access to any group of secure emergency shelters based on what type of subscription is obtained by the subscriber.

Much is known in the art regarding the construction and maintenance of shelters. Such a construction will usually at least serve to protect the inhabitants from environmental stress and extremes. In addition to walls and a roof, such a shelter will typically also comprise internal temperature control, lighting, storage facilities, sleeping facilities, food preparation facilities, personal hygiene facilities, and so forth. For present purposes such a shelter may also be equipped to provide for water treatment (such as filtering, bacteria removal, and so forth), waste treatment and/or recycling, electrical power generation, and/or air treatment (including but not limited to conditioning, filtering, and so forth). By one approach such a shelter can also be equipped with communication facilities including a variety of wireless broadcast capabilities, long-distance two-way communications capabilities, and so forth. Portable and/or temporary shelters are also possible. For example, an armored vehicle can be pre-configured to operate as a secure emergency shelter.

Security will likely comprise a primary concern for such a shelter. In particular it will likely be important to secure the shelter, any resources as are stored or otherwise available at the shelter, and the inhabitants of the shelter from unauthorized entry and access. By one approach, this can comprise maintaining the shelter in a location that is substantially distal from a nearest substantial human population. Another approach includes providing sufficient conventional armed security.

For a variety of reasons it may be appropriate to provide a plurality of such shelters in various locations throughout a relatively wide geographic region such as a continent or country. Such a dispersal can aid with reducing the logistic difficulties of transporting authorized beneficiaries to such a shelter during times of need. Dispersed shelters can also help ensure that at least some shelters will more likely survive civilly-catastrophic events that pose sufficient destructive force to destroy such a shelter.

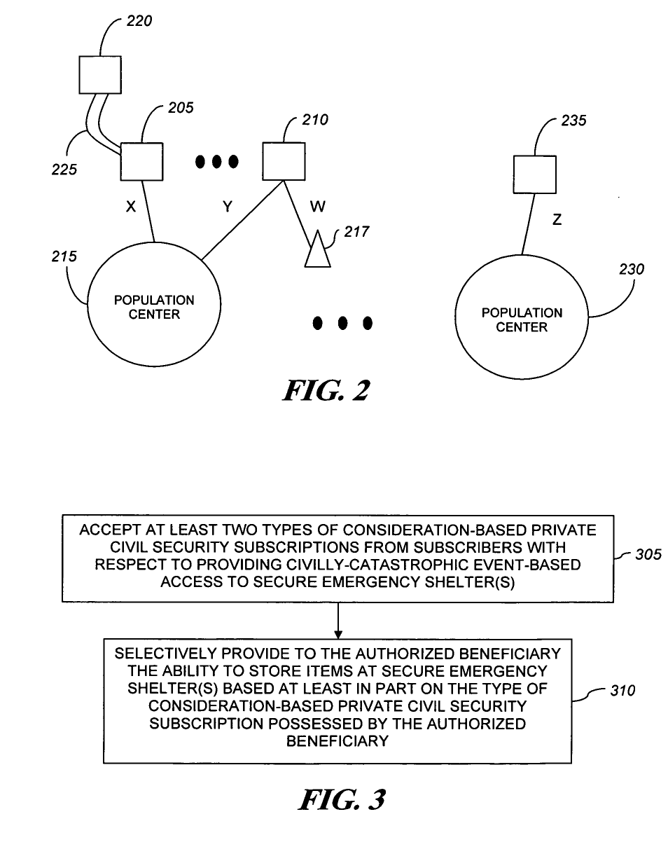

With reference to FIG. 2, various secure emergency shelter access options will be further explained. A plurality of secure emergency shelters 205 through 210 are positioned relative to a population center 215. Depending on the subscription obtained by the subscriber, authorized beneficiaries of the subscriber may have varying access to the secure emergency shelters 205 through 210. For instance, the subscriber may obtain a subscription type allowing authorized beneficiaries access to any of the secure emergency shelters 205 through 210. Alternatively, the subscriber may obtain a subscription allowing access to secure emergency shelters 205 within a specified geographical area such as within a given distance X from the population center; because a secure emergency shelter 210 lies a distance Y further from the population center, an authorized beneficiary would not have access to that secure emergency shelter 210. Alternatively, the specified geographical area may include a larger region or portion of land such as a state or group of states or portions of states.

Similarly, the subscriber may obtain a subscription allowing access to secure emergency shelters 210 within a given distance W of a rally point 217. The authorized beneficiaries may be instructed to move to a rally point 217 in the event of a civilly-catastrophic event to be transferred from the rally point 217 to a secure emergency shelter. Thus, authorized beneficiaries having a particular type of consideration based private civil security subscription may then have access only to secure emergency shelter 210 within a given distance W of the rally point 217 and not have access to other secure emergency shelters 205.

Such a rally point need not be reserved only for this purpose and may, for example, simply comprise a convenient location for at least some authorized beneficiaries. Example rally points might include sports stadiums and auditoriums, amusement parks, and the like. When possible, it may be helpful to locate such a rally point relatively near an airstrip and/or a navigable waterway. Such amenities, in turn, can potentially be used when transporting the gathered beneficiaries to their destination (as when, for example, a destination shelter is accessible from the navigable waterway that is also readily accessible from the rally point). By one approach, one or more such rally points can be identified for each larger population area that contains authorized beneficiaries. It would also be possible, of course, to identify rally points to serve a similar function in more rural settings as well if desired.

With reference to FIGS. 1 and 2, optionally, a provider may provide 120 an ability to access a series of secure emergency shelters 205 and 220. For instance, the series of secure emergency shelters 205 and 220 may provide increasingly secure shelters relative to the catastrophic event. For example, because civilly-catastrophic events may be more likely to occur in or near population centers 215, the series of secure emergency shelters 205 and 220 may allow the authorized beneficiary having this type of consideration based private civil security subscription the option of hopping through consecutive secure emergency shelters 205 and 220 to provide greater security and/or distance from the population center 215 or other insecure area.

In a further alternative, at least two of the secure emergency shelters 205 and 220 are connected by at least one secure passageway 225. The secure passageway 225 includes any method of secure transport between the secure emergency shelters 205 and 220. For example, the secure passageway 225 may include a secure underground tunnel, a secure rapid transit line, a secure vehicle (such as an armored vehicle or aircraft), or a secure caravan of vehicles fit for movement between the secure emergency shelters 205 and 220. Thus, one may selectively provide access for authorized beneficiaries of the subscribers to at least one secure passageway 225 in event of a catastrophic event based at least in part on the type of consideration-based private civil security subscription possessed by the authorized beneficiary.

In an alternative to providing access to a plurality of secure emergency shelters, one may assign 125 the authorized beneficiary to a secure emergency shelter wherein the types of consideration-based private civil security subscriptions available include an assigned type wherein an authorized beneficiary possessing the assigned type of consideration-based private civil security subscription only has access to an assigned secure emergency shelter in event of a catastrophic event. Typically, the authorized beneficiary is assigned to the assigned secure emergency shelter prior to the catastrophic event. In one approach, the authorized beneficiary is assigned based at least in part on a primary location associated with the authorized beneficiary.

For example, the authorized beneficiary may live in a population center 230 with a secure emergency shelter 235 located a distance Z from the population center 230. Thus, the population center 230 may be the primary location for the authorized beneficiary such that the authorized beneficiary will be assigned to the secure emergency shelter 235 nearest to the location. The primary location for an authorized beneficiary may be a second home or a primary work location or any other location designated by the authorized beneficiary or provider of the secure emergency shelters. Typically, the provider of the secure emergency shelters will assign the authorized beneficiaries to the secure emergency shelters to properly balance the demand for resources of the secure emergency shelters upon the occurrence of a civilly catastrophic event.

In a related approach, each authorized beneficiary is assigned to one of a plurality of secure emergency shelters prior to the catastrophic event. Then, access may be provided to a plurality of the secure emergency shelters for authorized beneficiaries possessing a premium-type subscription in event of the catastrophic event. In such an approach, the subscriber would provide increased consideration in exchange for the authorized beneficiaries' access to secure emergency shelters beyond the secure emergency shelter assigned to the authorized beneficiaries. Thus, the provider of the secure emergency shelters would obtain the necessary resources to maintain the capacity at the secure emergency shelters to handle the uncertainty of which secure emergency shelter various authorized beneficiaries may choose to access upon the occurrence of a catastrophic event.

In an alternative to providing access to a plurality of secure emergency shelters, one may provide access 130 for an authorized beneficiary to an available secure emergency shelter. Here, the types of consideration-based private civil security subscriptions available include an availability type wherein an authorized beneficiary possessing the availability type of consideration-based private civil security subscription has access to one of the secure emergency shelters only when space is available at one of the secure emergency shelters in event of a catastrophic event. This type of consideration-based private civil security subscription would typically be offered in exchange for a smaller amount of consideration because of a relative uncertainty in the type, location, or availability of a secure emergency shelter upon the occurrence of a civilly-catastrophic event and the decreased need for the provider of the secure emergency shelters to account for such authorized beneficiaries in managing the secure emergency shelters.

In another approach, one may provide access 135 for an authorized beneficiary to a secure emergency shelter with increased benefits. In such an approach, the types of consideration-based private civil security subscriptions available include an upgrade type wherein an authorized beneficiary possessing the upgrade option type of consideration-based private civil security subscription has selective access to at least one secure emergency shelter having increased benefits relative to the type of secure emergency shelter to which the authorized beneficiary has access in event of a catastrophic event. Alternatively, the types of consideration-based private civil security subscriptions available include an upgrade option type wherein an authorized beneficiary possessing the upgrade type of consideration-based private civil security subscription has access to at least one secure emergency shelter having increased benefits relative to the type of secure emergency shelter to which the authorized beneficiary has access only when the at least one secure emergency shelter having increased benefits has available space in event of a catastrophic event. Typically, holders of an upgrade type or upgrade option type of consideration-based private civil security subscription hold another type of consideration-based private civil security subscription from which the authorized beneficiary may upgrade. Optionally, the upgrade or upgrade option types of consideration-based private civil security subscriptions may be purchased upon arrival at a secure emergency shelter after the occurrence of a civilly-catastrophic event.

The types of increased benefits available at any given secure emergency shelter may vary greatly. For example, a secure emergency shelter may have a larger selection of foods or a larger amount of privacy available relative to the type of secure emergency shelter to which the authorized beneficiary has access. A secure emergency shelter having a larger amount of privacy, for instance, may have an increased amount of private space such as at least one of the following: personal hygiene facilities, personal storage space, personal food preparation facilities, personal external communications facilities, personal entertainment space, personal education space, personal training space, personal workshops, personal place to worship, and personal meeting facilities.

A secure emergency shelter optionally may have a larger selection of non-necessities available relative to the type of secure emergency shelter to which the authorized beneficiary has access. Examples of such non-necessities include: luxury consumable items, luxury non-consumable items, non-essential clothing, non-human nourishment, barter medium, entertainment apparatus, educational tools, physical conditioning, exercise, and maintenance training and equipment, crafts supplies and training, towels, bed linens, food preparation items, communication items, worship related items, and sports equipment and facilities. Many of the above also comprise a variety of non-consumable items of which a secure emergency shelter may have a larger selection available relative to the type of secure emergency shelter to which the authorized beneficiary has access.

Similarly, a secure emergency shelter may have a larger selection of consumable items available relative to the type of secure emergency shelter to which the authorized beneficiary has access. Examples of such consumable items include: food supplies, potable water, medical supplies, and hygiene supplies.

A secure emergency shelter may have increased security relative to the type of secure emergency shelter to which the authorized beneficiary has access. In yet another approach, a secure emergency shelter may have increased communications abilities available. Another alternative includes a secure emergency shelter having an increased availability of life sustaining resources relative to the type of secure emergency shelter to which the authorized beneficiary has access. The increased availability of life sustaining resources may include having an increased availability of hydration and/or nourishment supplies, shelter accommodations, and environmentally borne threat abatement capability.

Another way to distinguish a secure emergency shelter is by its having higher quality living quarters relative to the type of secure emergency shelter to which the authorized beneficiary has access. Higher quality living quarters may include, for example, a higher quality of sleeping accommodations, food preparation facilities, personal hygiene facilities, worship space, and sitting accommodations.

Another approach includes a secure emergency shelter having a larger availability of health care options available relative to the type of secure emergency shelter to which the authorized beneficiary has access. Another alternative includes a secure emergency shelter having a higher level of entertainment options available. Example improved entertainment options may include: a larger selection of videos, improved television reception, a larger selection of board, card, and/or video games, having access to live entertainment, having a larger selection of arts and crafts materials, having improved religious-activity related facilities, a larger workshop space, and a larger selection of reading materials.

In another approach, one may provide access 140 for a companion of an authorized beneficiary to a secure emergency shelter. In such an approach, the types of subscriptions available include a companion type of consideration-based private civil security subscription wherein at least one person who is not otherwise an authorized beneficiary and who is accompanying an authorized beneficiary possessing the companion type of consideration-based private civil security subscription has access to a secure emergency shelter in event of a catastrophic event. Optionally, the access for the at least one person may be based at least in part on a category of the companion type of consideration-based private civil security subscription possessed by the authorized beneficiary in event of a catastrophic event. In this way, the companion's options for accessing secure emergency shelters may vary in a manner similar to the options for an authorized beneficiary. Also, such a subscription provides an authorized beneficiary with the option of bringing a person of the authorized beneficiary's choosing to the secure emergency shelter without advance planning.

A further alternative may include a companion type of consideration-based private civil security subscription wherein at least one animal that is accompanying an authorized beneficiary possessing the companion type of consideration-based private civil security subscription has access to a secure emergency shelter in event of a catastrophic event. As such, an authorized beneficiary may bring a pet or working animal to the secure emergency shelter to provide further companionship and/or assistance.

Of course an acceptor of subscriptions may provide any combination of the above types of subscriptions for regulating access to secure emergency shelters. For example, the at least two types of consideration-based private civil security subscriptions may include an assigned type and an availability type of consideration-based private civil security subscription. A further option is where the at least two types of consideration-based private civil security subscriptions may include an assigned type, an availability type, and an open unassigned type wherein an authorized beneficiary possessing the open unassigned type of consideration-based private civil security subscription has access to a plurality of secure emergency shelters. Further combinations, of course, may be accepted and/or offered.

Optionally, the process 100 allows for providing the authorized beneficiary information 145 to determine a method to access a secure emergency shelter in event of a catastrophic event. A further option includes providing the authorized beneficiary the information to determine the method to access a secure emergency shelter when the authorized beneficiary possesses a premium-type of consideration-based private civil security subscription. Yet another option includes providing such information to the authorized beneficiary based a least in part on the type of consideration-based private civil security subscription possessed by the authorized beneficiary and a geographical location associated with the authorized beneficiary. For example, an authorized beneficiary that has access to a plurality of secure emergency shelters upon the occurrence of a catastrophic event will be provided information regarding the location and/or availability of particular secure emergency shelters whereas other authorized beneficiaries only having access to one secure emergency shelter or to particular secure emergency shelters within a geographical area will not receive such additional information.

The information for accessing a secure emergency shelter may be provided in any number of ways before, upon, or after an occurrence of a civilly catastrophic event given the uncertain nature of communications after such an event. Illustrative examples of providing the information include: providing a call-in network address for accessing the information, automatically providing an electronic message in response to receiving a travel message regarding the authorized beneficiary, providing a reference book listing the secure emergency shelters, providing a computer accessible database regarding the secure emergency shelters, providing a homing beacon that is trackable by the authorized beneficiary, providing a one-time-use security card, and providing a physical signal associated with a secure emergency shelter. Examples of such physical signals include: at least one sign, at least one lighting indicator, a smell, smoke, an infrared beacon, a strobe, sound, and a flare. The information exchange may be achieved using other such communication means as may be available at the time. It would also be possible to provision each authorized beneficiary (or family or company of beneficiaries) with one or more communications devices by which such information could be provided.

Alternatively, certain events may trigger the provision of information. For example, the process 100 provides for receiving 150 travel information regarding the authorized beneficiary and providing the information 145 in response to receiving the travel information. This portion of the process 100 applies, for instance, when the authorized beneficiary has access to a plurality of secure emergency shelters such that the authorized beneficiary may need access to such a shelter when traveling away from the authorized beneficiary's primary secure emergency shelter. Receiving information 150 prior to a catastrophic event regarding the movements of an authorized beneficiary also allows for adjusting 160 the accommodations at at least one of the plurality of secure emergency shelters in response to the information regarding the movements of the authorized beneficiary. Similarly, the information for accessing a secure emergency shelter may be provided in response to an inquiry 155 from the authorized beneficiary.

A further option for the process 100 includes providing 165 to the authorized beneficiary the ability to store at least one personalized item at a plurality of secure emergency shelters based at least in part on the type of consideration-based private civil security subscription possessed by the authorized beneficiary. In other words, the subscriber may obtain a subscription that would allow the authorized beneficiaries of the subscriber to store personalized items at a plurality of secure emergency shelters. The personalized items may be provided by the entity maintaining the secure emergency shelter, the subscriber, or the authorized beneficiary, and examples of those items include: specialized gear, personal dietary requirements, specialized clothing, specialized safety gear, specialized transport, personal worship related items, and personal medicine.

In another approach, one may provide card-based access 170 for an authorized beneficiary to a secure emergency shelter. In such an approach, the types of subscriptions available could include a card-based-access type of consideration-based private civil security subscription wherein a person possessing an access card issued to the subscriber has access to a plurality of secure emergency shelters in event of a catastrophic event. In such an embodiment, access to the secure emergency shelter is based upon a person's possession of a particular card that the subscriber may give to anyone.

With reference to FIG. 3, by another approach one may accept 305 at least two types of consideration-based private civil security subscriptions from subscribers with respect to providing civilly-catastrophic event-based access to secure emergency shelters, and selectively provide 310 to the authorized beneficiary the ability to store items at a plurality of secure emergency shelters based at least in part on the type of consideration-based private civil security subscription possessed by the authorized beneficiary. In other words, the consideration-based private civil security subscriptions in some situations may allow for the opportunity to store items separately from the opportunity to access secure emergency shelters. As described above, the stored items may include: specialized gear, personal dietary requirements, specialized clothing, specialized safety gear, specialized transport, personal worship related items, and personal medicine, to note but a few relevant examples.

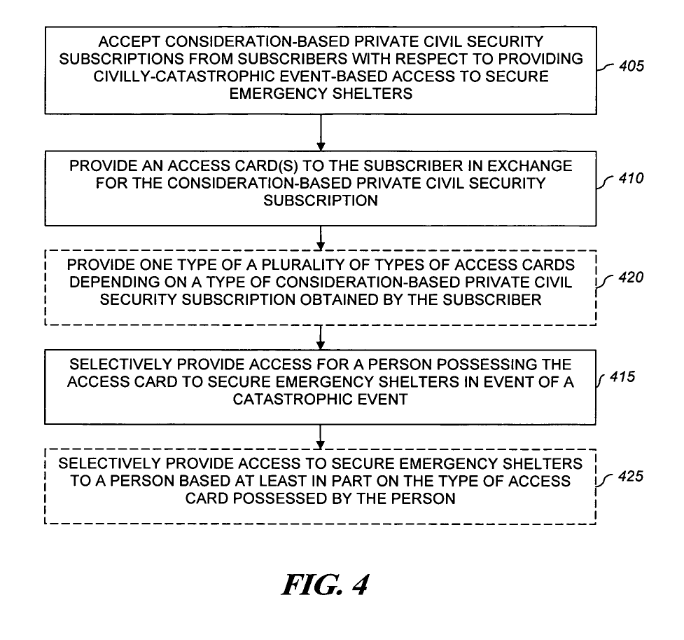

With reference to FIG. 4, another approach includes accepting 405 consideration-based private civil security subscriptions from subscribers with respect to providing civilly-catastrophic event-based access to secure emergency shelters, and providing 410 an access card to the subscriber in exchange for the consideration-based private civil security subscription. Then, the process includes selectively providing 415 access for a person possessing the access card to secure emergency shelters in event of a catastrophic event. Optionally, the subscriber may be provided a plurality of access cards in exchange for consideration-based private civil security subscriptions. Thus, a subscriber may obtain many cards to distribute at will. Then, access to at least one secure emergency shelter may be selectively provided to any person possessing an access card provided to the subscriber.

Optionally, the access card may be a one-time-use card. An example of a one-time-use card includes one that a person may break open in the event of a civilly catastrophic event, and an inner portion of the card instructs the person as to the location of or method of access for a secure emergency shelter. Such cards may be periodically reissued or updated thereby rendering previous cards obsolete.

Another option includes providing 420 one type of a plurality of types of access cards depending on a type of consideration-based private civil security subscription obtained by the subscriber. Then, the process includes selectively providing 425 access to secure emergency shelters to a person based at least in part on the type of access card possessed by the person. In this way, the access card may convey the amount of access to secure emergency shelters a possessor of the access card has. The levels of card-based access can thus vary as much as the types of subscriptions may vary.

Thus configured, the process allows for accepting various types of consideration-based private civil security subscriptions for accessing secure emergency shelters in the event of a civilly-catastrophic event. The subscriber may then tailor the subscriptions to the subscriber's or authorized beneficiary's needs. Further, the acceptor of the subscriptions may then accept varying amounts of consideration to allow for the provisions and maintenance of the secure emergency shelters.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept. As but one example in this regard, such subscriptions may differ from one another with respect to post-catastrophic event access to educational and/or training materials, programs, instructors, and so forth. Such facilities could serve, for example, to continue, essentially without disruption, a young person's education.

I claim:

1. A method comprising:
accepting at least two types of consideration-based private civil security subscriptions from subscribers with respect to providing civilly-catastrophic event-based access to secure emergency shelters; and
selectively providing access for authorized beneficiaries of the subscribers to secure emergency shelters in event of a catastrophic event based at least in part on the type of consideration-based private civil security subscription possessed by the authorized beneficiary.

2. The method of claim 1 wherein the secure emergency shelters comprise secure multi-person emergency shelters.

3. The method of claim 1 wherein the at least two types of consideration-based private civil security subscriptions further comprise a first type wherein an authorized beneficiary possessing the first type of consideration-based private civil security subscription has access to a plurality of secure emergency shelters in event of a catastrophic event.

4. The method of claim 3 wherein the plurality of secure emergency shelters further comprises any secure emergency shelter having a particular category of amenities.

5. The method of claim 3 wherein the plurality of secure emergency shelters further comprises any secure emergency shelter.

6. The method of claim 3 wherein the plurality of secure emergency shelters further comprises any secure emergency shelter within a specified geographical area.

7. The method of claim 3 wherein the plurality of secure emergency shelters further comprises any secure emergency shelter within a given distance of a rally point.

8. The method of claim 1 wherein the at least two types of consideration-based private civil security subscriptions further comprise an assigned type wherein an authorized beneficiary possessing the assigned type of consideration-based private civil security subscription only has access to an assigned secure emergency shelter in event of a catastrophic event.

9. The method of claim 8 further comprising assigning the authorized beneficiary to the assigned secure emergency shelter prior to the catastrophic event.

10. The method of claim 9 further comprising assigning the authorized beneficiary to the assigned secure emergency shelter prior to the catastrophic event based at least in part on a primary location associated with the authorized beneficiary.

11. The method of claim 1 wherein the at least two types of consideration-based private civil security subscriptions further comprise an availability type wherein an authorized beneficiary possessing the availability type of consideration-based private civil security subscription has access to one of the secure emergency shelters only when space is available at one of the secure emergency shelters in event of a catastrophic event.

12. The method of claim 1 wherein the at least two types of consideration-based private civil security subscriptions further comprise an upgrade type wherein an authorized beneficiary possessing the upgrade type of consideration-based private civil security subscription has selective access to at least one secure emergency shelter having increased benefits relative to the type of secure emergency shelter to which the authorized beneficiary has access in event of a catastrophic event.

13. The method of claim 12 wherein the at least one secure emergency shelter having increased benefits relative to the type of secure emergency shelter to which the authorized beneficiary has access further comprises at least one of a group of secure emergency shelters comprising:
a secure emergency shelter having a larger selection of foods available relative to the type of secure emergency shelter to which the authorized beneficiary has access;
a secure emergency shelter having a larger amount of privacy available relative to the type of secure emergency shelter to which the authorized beneficiary has access;
a secure emergency shelter having a larger selection of non-necessities available relative to the type of secure emergency shelter to which the authorized beneficiary has access;
a secure emergency shelter having a larger selection of consumable items available relative to the type of secure emergency shelter to which the authorized beneficiary has access;
a secure emergency shelter having a larger selection of non-consumable items available relative to the type of secure emergency shelter to which the authorized beneficiary has access;
a secure emergency shelter having increased security relative to the type of secure emergency shelter to which the authorized beneficiary has access;
a secure emergency shelter having increased communications abilities available relative to the type of secure emergency shelter to which the authorized beneficiary has access;
a secure emergency shelter having an increased availability of life sustaining resources relative to the type of secure emergency shelter to which the authorized beneficiary has access;
a secure emergency shelter having higher quality living quarters relative to the type of secure emergency shelter to which the authorized beneficiary has access;
a secure emergency shelter having a larger availability of health care options available relative to the type of secure emergency shelter to which the authorized beneficiary has access; and
a secure emergency shelter having a higher level of entertainment options available relative to the type of secure emergency shelter to which the authorized beneficiary has access.

14. The method of claim 13 wherein having a larger amount of privacy available further comprises having an increased amount of private space comprising at least one of the group comprising:
personal hygiene facilities;
personal storage space;
personal food preparation facilities;
personal external communications facilities;
personal entertainment space;
personal education space;
personal training space;
personal workshops;
personal place to worship; and
personal meeting facilities.

15. The method of claim 13 wherein the non-necessities further comprise at least one of the group comprising:
luxury consumable items;
luxury non-consumable items;
non-essential clothing;
non-human nourishment;
barter medium;
entertainment apparatus;
educational tools;
physical conditioning, exercise, and maintenance training and equipment;
crafts supplies and training;
towels;
bed linens;
food preparation items;
communication items;
worship related items; and
sports equipment and facilities.

16. The method of claim 13 wherein the consumable items further comprise at least one of the group comprising:
food supplies;
potable water;
medical supplies; and
hygiene supplies.

17. The method of claim 13 wherein having an increased availability of life sustaining resources further comprises having a an increased availability of at least one of the group comprising:
hydration;
nourishment;
shelter; and
environmentally borne threat abatement.

18. The method of claim 13 wherein having higher quality living quarters further comprises having a higher quality of at least one of the group comprising:
sleeping accommodations;
food preparation facilities;
personal hygiene facilities;
worship space; and
sitting accommodations.

19. The method of claim 13 wherein having a higher level of entertainment options available further comprises having at least one of the group comprising:
a larger selection of videos;
improved television reception;
a larger selection of games;
having access to live entertainment;
having a larger selection of arts and crafts materials;
having improved religious-activity related facilities;
a larger workshop space; and
a larger selection of reading materials.

20. The method of claim 1 wherein the at least two types of consideration-based private civil security subscriptions further comprise:
an assigned type of consideration-based private civil security subscription wherein an authorized beneficiary possessing the assigned type of consideration-based private civil security subscription only has access to an assigned secure emergency shelter in event of a catastrophic event; and
an availability type of consideration-based private civil security subscription wherein an authorized beneficiary possessing the availability type of consideration-based private civil security subscription has access to one of the secure emergency shelters only when space is available at one of the secure emergency shelters in event of a catastrophic event.

21. The method of claim 1 wherein an authorized beneficiary possessing an upgrade option type of consideration-based private civil security subscription wherein an authorized beneficiary possessing the upgrade option type has access to at least one secure emergency shelter having increased benefits relative to the type of secure emergency shelter to which the authorized beneficiary has access only when the at least one secure emergency shelter having increased benefits has available space in event of a catastrophic event.

22. The method of claim 1 wherein the at least two types of consideration-based private civil security subscriptions further comprise a companion type of consideration-based private civil security subscription wherein at least one person who is not otherwise an authorized beneficiary and who is accompanying an authorized beneficiary possessing the companion type of consideration-based private civil security subscription has access to a secure emergency shelter in event of a catastrophic event.

23. The method of claim 22 further comprising providing access for the at least one person based at least in part on a category of the companion type of consideration-based private civil security subscription possessed by the authorized beneficiary in event of a catastrophic event.

24. The method of claim 1 wherein the at least two types of consideration-based private civil security subscriptions further comprise a companion type of consideration-based private civil security subscription wherein at least one animal that is accompanying an authorized beneficiary possessing the companion type of consideration-based private civil security subscription has access to a secure emergency shelter in event of a catastrophic event.

25. The method of claim 1 further comprising assigning each authorized beneficiary to one of a plurality of secure emergency shelters prior to the catastrophic event.

26. The method of claim 25 further comprising providing access to a plurality of secure emergency shelters to authorized beneficiaries possessing a premium-type subscription in event of a catastrophic event.

27. The method of claim 1 wherein the at least two types of consideration-based private civil security subscriptions further comprise:
an assigned type wherein an authorized beneficiary possessing the assigned type of consideration-based private civil security subscription only has access to a secure emergency shelter to whom the authorized beneficiary was assigned in event of a catastrophic event;
an unassigned type wherein an authorized beneficiary possessing the unassigned type of consideration-based private civil security subscription only has access to a secure emergency shelter at which space is available in event of a catastrophic event; and
an open unassigned type wherein an authorized beneficiary possessing the open unassigned type of consideration-based private civil security subscription has access to a plurality of secure emergency shelters.

28. The method of claim 1 further comprising providing the authorized beneficiary information to determine a method to access a secure emergency shelter in event of a catastrophic event.

29. The method of claim 28 further comprising providing the information in response to receiving travel information regarding the authorized beneficiary.

30. The method of claim 28 further comprising providing the information in response to an inquiry from the authorized beneficiary.

31. The method of claim 28 further comprising providing the authorized beneficiary the information to determine the method to access a secure emergency shelter when the authorized beneficiary possesses a premium-type of consideration-based private civil security subscription.

32. The method of claim 28 further comprising providing the authorized beneficiary information to determine a method to access a secure emergency shelter in event of a catastrophic event based at least in part on the type of consideration-based private civil security subscription possessed by the authorized beneficiary and a geographical location associated with the authorized beneficiary.

33. The method of claim 28 wherein providing the authorized beneficiary the information comprises at least one of:
providing a call-in network address for accessing the information;
automatically providing an electronic message in response to receiving a travel message regarding the authorized beneficiary;
providing a reference book listing the secure emergency shelters;
providing a computer accessible database regarding the secure emergency shelters;
providing a homing beacon that is trackable by the authorized beneficiary;
providing a one-time-use security card; and
providing a physical signal associated with a secure emergency shelter.

34. The method of claim 33 wherein the physical signal comprises at least one of the group comprising:
at least one sign;
at least one lighting indicator;
a smell;
smoke;
an infrared beacon;
a strobe;
sound; and
a flare.

35. The method of claim 1 wherein the two types of consideration-based private civil security subscriptions at least comprise a first type that provides relatively limited access to the secure emergency shelters and a second type that provides relatively less limited access to the secure emergency shelters.

36. The method of claim 1 further comprising:
prior to the catastrophic event:
receiving information regarding movements of an authorized beneficiary;
adjusting accommodations at at least one of the plurality of secure emergency shelters in response to the information regarding the movements of the authorized beneficiary.

37. The method of claim 1 wherein the first type of consideration-based private civil security subscription permits access to only a relatively few of the plurality of secure emergency shelters and the second type of consideration-based private civil security subscription permits access to substantially any of the plurality of secure emergency shelters.

38. The method of claim 37 wherein the first type of consideration-based private civil security subscription permits access to only a predetermined one of the plurality of secure emergency shelters.

39. The method of claim 1 wherein selectively providing access for authorized beneficiaries of the subscribers to secure emergency shelters in event of a catastrophic event based at least in part on the type of consideration-based private civil security subscription possessed by the authorized beneficiary further comprises providing an ability to access a series of secure emergency shelters.

40. The method of claim 39 wherein the series of secure emergency shelters further comprises increasingly secure shelters relative to the catastrophic event.

41. The method of claim 1 further comprising providing to the authorized beneficiary the ability to store at least one personalized item at a plurality of secure emergency shelters based at least in part on the type of consideration-based private civil security subscription possessed by the authorized beneficiary.

42. The method of claim 40 wherein the at least one personalized item further comprises at least one of a group comprising:
specialized gear;
personal dietary requirements;
specialized clothing;
specialized safety gear;
specialized transport;
personal worship related items; and
personal medicine.

43. The method of claim 1 wherein at least two of the secure emergency shelters are connected by at least one secure passageway.

44. The method of claim 43 further comprising selectively providing access for authorized beneficiaries of the subscribers to at least one of the at least one secure passageway in event of a catastrophic event based at least in part on the type of consideration-based private civil security subscription possessed by the authorized beneficiary.

45. The method of claim 1 wherein the at least two types of consideration-based private civil security subscriptions further comprise a card-based-access type wherein a person possessing an access card issued to the subscriber has access to a plurality of secure emergency shelters in event of a catastrophic event.

46. A method comprising:
accepting at least two types of consideration-based private civil security subscriptions from subscribers with respect to providing civilly-catastrophic event-based access to secure emergency shelters; and
selectively providing to the authorized beneficiary the ability to store items at a plurality of secure emergency shelters based at least in part on the type of consideration-based private civil security subscription possessed by the authorized beneficiary.

47. The method of claim 46 wherein the items further comprise at least one of a group comprising:
specialized gear;
personal dietary requirements;
specialized clothing;
specialized safety gear;
specialized transport;
personal worship related items; and
personal medicine.

48. A method comprising:
accepting consideration-based private civil security subscriptions from subscribers with respect to providing civilly-catastrophic event-based access to secure emergency shelters;
providing an access card to the subscriber in exchange for the consideration-based private civil security subscription; and
selectively providing access for a person possessing the access card to secure emergency shelters in event of a catastrophic event.

49. The method of claim 48 wherein providing the access card to the subscriber in exchange for the consideration-based private civil security subscription further comprises providing a plurality of access cards to the subscriber in exchange for consideration-based private civil security subscriptions.

50. The method of claim 49 wherein selectively providing access for a person possessing the access card to secure emergency shelters in event of a catastrophic event further comprises selectively providing access to at least one secure emergency shelter to any person possessing an access card provided to the subscriber.

51. The method of claim 48 wherein the access card is a one-time-use card.

52. The method of claim 48 further comprising:
providing one type of a plurality of types of access cards depending on a type of consideration-based private civil security subscription obtained by the subscriber; and
selectively providing access to secure emergency shelters to a person based at least in part on the type of access card possessed by the person.
